(19) United States
(12) Patent Application Publication
(10) Pub. No.: US 2023/0222061 A1
(43) Pub. Date: Jul. 13, 2023

(54) COMPUTER-IMPLEMENTED METHOD FOR MANAGING MEMORY AREAS OF A MEMORY UNIT IN A PROCESSING UNIT

(71) Applicant: Robert Bosch GmbH, Stuttgart (DE)

(72) Inventors: Arne Hamann, Ludwigsburg (DE); Dakshina Narahari Dasari, Boeblingen (DE); Falk Rehm, Renningen (DE); Michael Pressler, Karlsruhe (DE)

(21) Appl. No.: 18/150,601

(22) Filed: Jan. 5, 2023

(30) Foreign Application Priority Data
Jan. 12, 2022 (DE) 10 2022 200 252.0

(51) Int. Cl. G06F 12/0806

(52) U.S. Cl. CPC G06F 12/0806; G06F 2212/1016

(57) ABSTRACT

A computer-implemented method for managing memory areas of a memory unit in a processing unit. The method includes determining, upon occurrence of a predefined event, a memory configuration profile according to which individual processes are in each case allowed to access individual memory areas of the memory unit, configuring the memory unit according to the determined memory configuration profile in such a way that the individual processes are in each case allowed to access individual memory areas of the memory unit, analyzing a performance of the processing unit while the particular processes are being executed in the processing unit and are accessing the individual memory areas according to the determined memory configuration profile, and providing a result of the analysis which describes the performance of the processing unit as a function of the determined memory configuration profile.

### FIELD

The present invention relates to a computer-implemented method for managing memory areas of a memory unit in a processing unit, and a processing unit and a computer program for carrying out the method.

### BACKGROUND INFORMATION

In processing units, shared memory units may be provided, to which various processor cores or various processes, applications, or tasks may make shared access. However, there is a risk that individual processes may adversely affect one another. For example, if two processes jointly access the same memory area of the memory unit, one of the processes may, for example, replace, delete, or overwrite data that the other of the two processes has stored there. Such memory collisions may result in runtime losses of the processes, and may have a negative impact on the performance of the overall processing unit. It is important to avoid such memory collisions in memory units.

### SUMMARY

According to the present invention, a computer-implemented method for managing memory areas of a memory unit in a processing unit, and a processing unit and a computer program for carrying out the method are provided. Advantageous embodiments of the present invention are disclosed herein.

The memory unit is in particular provided as a shared memory unit which various processes or applications or tasks may jointly and in particular simultaneously access. The present invention provides an option to manage and allocate memory areas of the memory unit and individually assign single processes to same in such a way that processes in the processing unit do not adversely affect one another, and memory collisions in the memory unit and performance losses in the processing unit do not result.

Within the scope of the method according to an example embodiment of the present invention, when a predefined event occurs, a memory configuration profile or a memory assignment profile is determined, according to which individual processes, applications, or tasks are in each case allowed to access individual memory areas of the memory unit. This memory configuration profile is in particular determined online during regular operation of the processing unit. In particular, information concerning the particular processes to be executed in the processing unit are taken into account for this purpose.

For example, a process in question may be allowed to access an individual memory area or also multiple memory areas. In particular, for determining the memory configuration profile, in general it may be initially determined how many memory areas a particular process is allowed to access. It may subsequently be determined in particular which specific memory areas this process is allowed to access. The assignment of memory areas is advantageously unambiguous, so that only the assigned process is allowed to access the particular specific memory area. It is understood that all memory areas do not necessarily have to be assigned to a process in each case.

Within the scope of the method according to an example embodiment of the present invention, configuring of the memory unit according to the determined memory configuration profile also takes place in such a way that the individual processes in each case are allowed to access the particular individual memory areas of the memory unit. In particular, the determined memory configuration profile in the memory unit is implemented in this step. For example, for this purpose entries in a memory management table, according to which allowed accesses to the individual memory areas of the memory unit are defined, may be appropriately changed. In addition, for example a bit in an operating system of the processing unit may be set or changed prior to the start of the particular process. The individual particular processes may advantageously now be executed during regular operation of the processing unit.

After the configuring of the memory unit, within the scope of the method according to an example embodiment of the present invention, a performance of the processing unit is analyzed while the particular processes are being executed in the processing unit and are accessing the individual memory areas according to the determined memory configuration profile. In particular, in the course of this analysis the development of the performance due to the assignment of the individual memory areas may be monitored. Effects of the determined memory configuration profile on the performance may be advantageously monitored. It may particularly advantageously be analyzed whether the performance by the determined memory configuration profile is improved or worsened. In particular, the capability or efficiency of the processing unit and also in particular execution times of the process executed in the processing unit, or the effectiveness with which these processes are executed, may be taken into account as performance.

A result of the analysis is provided which describes or characterizes the performance of the processing unit as a function of the determined memory configuration profile. In particular, the analysis result correlates the performance with the memory configuration profile. A correlation of the memory configuration profile and the performance may be advantageously determined. For example, such a relation or correlation may be individually determined for each process, for example according to the particular execution time for this process that may be achieved by assignment of appropriate memory areas. The analysis result together with the memory configuration profile may be advantageously stored or archived in the processing unit.

According to an example embodiment of the present invention, the steps of determining the memory configuration profile, configuring the memory unit, analyzing the performance, and providing the result of the analysis are particularly advantageously iteratively repeated during regular operation of the processing unit, in particular in each case upon occurrence of the predefined event. A present allocation of the memory areas may thus be made possible in a particularly advantageous manner, based on the processes to be executed at that time. In addition, the memory configuration profile may be continuously analyzed and improved.

The present invention allows specific individual memory areas to be exclusively assigned to particular processes, so that no conflicts or collisions can occur when these memory areas are accessed. In addition, monitoring the efficiency of these memory assignments and thus improving them over the long term may be made possible. The present method in particular provides a memory management mechanism that allows temporal isolation and freedom from interference when various applications are executed in the processing unit at the same time and jointly access the memory unit. A best possible assignment of memory areas may thus be advantageously found when the size of data to be written of all simultaneously executed processes is greater than the size or capacity of the memory unit. The memory management mechanism is particularly advantageously self-regulating, and may be integrated into the processing unit with little technical complexity. In addition, in particular a particularly simple memory assignment is made possible, since in particular no memory areas are migrated into other memory units, for example into other reserved memory pools, and instead, particularly advantageously only one bit in an operating system of the processing unit is set or reset prior to the start of a process.

According to an example embodiment of the present invention, in the course of the analysis, it may particularly advantageously be monitored whether the individual processes also actually access the particular memory areas that they are allowed to access according to the memory configuration profile, or in general it may be monitored whether the individual memory areas are also actually accessed. In this way, in particular the situation may be prevented that individual memory areas are blocked although they are not utilized, and thus displace other, important memory areas. If it is recognized in the course of the analysis that a memory area is blocked and is not utilized according to the memory configuration profile, this memory area may in particular be freed up, and for example cached, used, or assigned in some other way.

According to an example embodiment of the present invention, in the course of the configuring, the individual memory areas may, for example, be specifically assigned to the particular processes, for example in the course of “memory mapping,” for example by assigning specific memory addresses of the memory areas to the particular processes (so-called “cache coloring”). However, the configuring may also advantageously take place without such specific assignment or mapping. For example, a basic association of memory areas with processes may take place. In the course of the configuring, the particular memory areas may advantageously be reserved in general or in principle for accesses. In the course of the analysis, it may in particular be monitored whether actual accesses to the correspondingly reserved memory areas take place. The specific access of a particular process to a correspondingly reserved memory area with the aid of specific memory addresses may take place via the particular processor unit, for example.

The memory configuration profile may particularly advantageously be determined dynamically and online during operation of the processing unit, and specifically adapted to the processes to be carried out at the time. A dynamic response may particularly advantageously be made to changing conditions in the processing unit, for example to changing inputs of individual processes or to different processes to be executed in the processing unit, for example when a process presently being carried out is ended and not further executed, or when a new process is to be executed. The memory configuration profile may particularly advantageously be dynamically adapted online and continuously improved in order to achieve the best possible performance of the processing unit and of the individual executed processes. For example, data-dependent execution times may thus be managed.

The individual processes or applications executed in the processing unit may in particular have different quality requirements with regard to quality or quality of service (QoS). QoS is a measure for how closely the quality of a service matches the requirements. Depending on the type and priority of the particular application, the individual processes may respond differently to delays in their execution. For example, the individual processes may have individual requirements regarding latency, throughput, or so-called “best effort.” The present method allows in a particularly advantageous manner the quality requirements of the individual processes to be achieved in the best way possible, and high quality of service to be achieved. For this purpose, in particular assigning the memory areas or determining the memory configuration profile may take place as a function of QoS requirements of the individual processes. A QoS-conscious memory assignment may thus be made possible in a particularly advantageous manner to allow differentiated performance improvements for time-critical applications.

The particular processes particularly advantageously include time-critical processes or real-time processes that are to meet a real-time condition, and/or best effort processes that are to be executed as quickly as possible according to the so-called best effort principle. These two types of processes each have different requirements regarding time criticality and priority. The method is particularly suitable when combinations of these two types of processes are executed at the same time in the processing unit. A sufficient number of memory areas may advantageously be individually assigned in each case to these different processes so that the requirements of the particular processes are met.

In particular, the individual memory areas are to be understood as so-called “memory pages,” in particular as virtual or logical memory areas that may be addressed with the aid of virtual or logical memory addresses. For example, a memory management unit (MMU) may be provided to translate these virtual memory addresses into actual, physical memory addresses and to map the virtual memory areas onto actual, physical memory areas (so-called “memory frames”).

According to an example embodiment of the present invention, the memory unit is particularly advantageously provided as a cache memory. In particular, data that are accessed most frequently by the processor or the processor cores may be stored in such a cache memory. For example, the cache memory may be subdivided according to a predefined cache hierarchy. Thus, for example, a so-called level 1 or L1 cache may be provided as the highest hierarchy level which may be accessed with a quick or quickest access time, but which includes a small or smallest memory capacity. With a decreasing hierarchy level (level 2 to level n), in particular the access time decreases, but the memory capacity increases.

According to an example embodiment of the present invention, determining the memory configuration profile is advantageously carried out as a function of process information that describes a relevance or priority or criticality of individual processes to be executed on the processing unit. In particular, the process information describes whether the processes in each case are a time-critical process. If this is the case, the process information may also describe the real-time condition to be met. In addition, the process information may in particular describe requirements or QoS requirements as well as assigned priority values of the individual processes. Based on this process information, appropriate memory areas may be assigned to the particular processes in such a way that the requirements imposed on the process may be met.

Alternatively or additionally, determining the memory configuration profile is advantageously carried out as a function of an access profile that describes accesses of the memory unit by the individual processes to be executed on the processing unit. This access profile describes in particular the number of data which are accessed by the individual processes in the course of their execution, or which are cached by the processes during their execution. In addition, the access profile describes in particular the number of memory areas that are accessed by a particular process during its execution, and also in particular whether and how often the particular process re-accesses the same memory area, and also in particular a relevance of individual memory areas or memory accesses for the particular process. Based on this access profile, for determining the memory configuration profile an assessment may advantageously be made of how many memory areas are required for executing a particular process.

According to an example embodiment of the present invention, the process information and/or the access profile may be predefined, for example, by a manufacturer, for example, and read in as input values for determining the memory configuration profile. In addition, the process information and/or the access profile themselves/itself may be determined. For example, for this purpose the individual processes may be executed in isolation during an offline phase, or for example a calibration phase or test phase may be carried out, the processes being executed according to representative test inputs.

For example, the process information and/or the access profile may also be determined with the aid of statistical methods. For this purpose, for example in the course of a preprocessing phase, initial setpoint values for a statistical model, in particular a so-called “surrogate model,” may be determined. The model may then be used online during stationary operation of the processing unit in order to predict the presently required number of memory areas for individual processes. By observing the memory areas that are actually utilized, updated setpoint values may be added to the model in order to improve the accuracy of the prediction over the run time.

In addition, according to an example embodiment of the present invention, the process information and/or the access profile may be determined, for example, by analyzing a code underlying the processes, for example with the aid of static analytical tools.

In the process, for example determined code blocks may be identified, for example blocks that are used once and that cannot be cached, or for example code blocks that are called up repeatedly in the course of loops or functions, and that show high locality and therefore are cached often.

The occurrence of the predefined event advantageously includes receiving a request for executing, or starting one or multiple processes and/or ending the execution of one or multiple processes. Such an end of the execution may include, for example, a regular full execution of the particular process or also an error-related abortion of the particular process. In particular, the memory configuration profile may thus be redetermined each time a new process is to be started or when a process ends and is executed for a longer time. The memory areas may thus always be optimally allocated over the processes to be executed at the time. If the process to be started is, for example, a process that has already been executed in the processing unit, in particular a previously determined memory configuration profile may be accessed in which particular memory areas have already been assigned to this process. For example, if a new process is to be started that has not yet been executed in the processing unit, in particular a completely new memory configuration profile may be determined. After the process is ended, the memory areas assigned to this process may advantageously be reallocated and assigned to other processes.

Alternatively or additionally, the occurrence of the predefined event advantageously includes an expiration of a predefined time interval. In particular, the memory configuration profile may thus be periodically redetermined at regular time intervals and continuously adapted to the processes to be executed at the time.

Alternatively or additionally, the occurrence of the predefined event advantageously includes the occurrence of a predefined criterion, in particular a criterion relating to the performance. For example, this criterion may indicate that the present memory configuration profile has not been optimally selected, or that memory collisions or time losses result. For example, the occurrence of this predefined criterion may include reaching a threshold value of a number of failed memory accesses or memory lapses, for example so-called “cache misses.”

According to one preferred specific embodiment of the present invention, in the course of analyzing the performance of the processing unit, performance properties are determined, advantageously while the particular processes are being executed in the processing unit and are accessing the individual memory areas according to the determined memory configuration profile. These performance properties describe a present performance or effectiveness of the execution of the individual particular processes and/or a present performance or effectiveness of the operation of the overall processing unit. For example, these performance properties may describe execution times, latencies, or waiting times as well as successful or unsuccessful memory accesses, for example.

According to an example embodiment of the present invention, the determined performance properties are particularly preferably compared to predefined performance conditions that describe a predefined performance or effectiveness for the execution of the individual particular processes and/or a predefined performance or effectiveness for the operation of the overall processing unit. For example, the performance properties may be present actual values, and the performance conditions may, for example, be corresponding setpoint values, limiting values, or threshold values for the performance properties.

The result of the analysis is preferably provided for use or taking into account for determining the memory configuration profile upon a next occurrence of the predefined event. A redetermination of the memory configuration profile preferably takes place during a next occurrence of the predefined event as a function of the most recently determined memory configuration profile, or as a function of the memory configuration profile determined for the previous occurrence of the predefined event, and as a function of the provided result of the analysis. In particular, based on the analysis result it may be assessed whether it has been possible for the most recently determined memory configuration profile to achieve good performance. With the aid of the analysis result, the memory configuration profile may be improved, if necessary, upon the next occurrence of the event. In particular, a self-regulating, self-learning memory management mechanism may thus be provided, so that over time the best possible allocation of memory areas may be found and individually adapted to the specific processing unit. In the course of the analysis it may particularly advantageously be recognized when individual memory areas are not accessed and these memory areas are thus unnecessarily blocked. Memory areas that are blocked in this way may advantageously be freed up upon the next determination of the memory configuration profile.

For redetermining the memory configuration profile, the most recently determined memory configuration profile is preferably used when as the result of the analysis it is determined that the performance properties match or at least essentially match the predefined performance conditions. In this case, the most recent memory configuration profile in particular has already been determined well enough, so that the actual performance values may correspondingly reach predefined setpoint values. In contrast, if it is determined as the result of the analysis that the performance properties deviate from the predefined performance conditions, the most recently determined memory configuration profile is preferably adapted. This adaptation advantageously takes place as a function of the deviation of the performance properties from the predefined performance conditions. In particular, a regulation of the performance may be achieved, so that over time the best possible allocation of the memory areas may be learned.

In particular, such a use or adaptation of the most recently determined memory configuration profile takes place when, upon the next occurrence of the predefined event, one or multiple of the particular processes are to be executed in the processing unit as for the previous occurrence of the predefined event. In contrast, if new processes which have not yet been executed in the processing unit are to be executed upon the next occurrence of the predefined event, a completely new memory configuration profile may advantageously be determined. For example, a new memory configuration profile may be determined with the aid of a heuristic algorithm or an evolutionary or genetic algorithm, also using a fitness function or machine learning, for example.

The performance of the processing unit advantageously relates to a response time or an execution time, latency, or waiting time of the individual particular processes, for example considered in a predefined time interval. Alternatively or additionally, the performance of the processing unit advantageously relates to errors when accessing data of the individual particular processes. For example, for this purpose cache misses or a cache miss rate may be taken into account. Similarly, for example accesses that are successfully carried out (cache hits) may also be taken into account. For example, response times and/or access errors of all executed processes, or also only of selected processes, for example only time-critical processes or best effort processes, may be taken into account. In particular, the performance properties may represent present actual values for these values, and the performance conditions may advantageously represent predefined setpoint values.

According to one preferred specific embodiment of the present invention, determining the memory configuration profile and an in particular specific assignment of the memory areas may be combined with partitioning of the memory unit, particularly advantageously software-based partitioning. For this purpose, a specific partition index value or a specific value of a partition index may be associated in each case with the individual memory areas. Memory areas having the same partition index value jointly form a partition. Similarly, a partition index value may be associated in each case with the individual processor cores or the individual processes. The individual processor cores or processes may thus be associated with individual partitions. Processor cores or processes having a particular associated index value may then access only those memory areas with which the same index value is associated. For example, multiple various partition index values may also be associated with individual processor cores or processes, so that these processor cores or processes may also access different partitions. It is advantageous that only one partition index value is unambiguously associated with the individual memory areas. For example, a color may be associated in each case as such partition index values (so-called “coloring,” “cache coloring,” or “page coloring”).

In the course of such software-based partitioning, in particular adjacent physical memory areas (memory frames) do not necessarily have to form a shared partition in the memory unit; rather, physical memory areas allocated in the memory unit may be arbitrarily combined to form a partition. For example, adjacent virtual memory areas (adjacent memory pages), but which are translated into nonadjacent physical memory areas (nonadjacent memory frames), may be combined to form a partition.

According to one advantageous specific embodiment of the present invention, at least one partition index value is associated in each case with the processes to be executed in the processing unit. As explained above, in this way the processes may be associated with a partition of the memory unit. In particular, at least one partition index value may be associated in each case with all processes. For example, this association may be made a priori or offline, for example in a manufacturing or programming process, before the processing unit is put into operation. For determining the memory configuration profile, preferably a partition index value is associated in each case with the individual memory areas of the memory unit in order to assign these memory areas in each case to a particular process with which the same partition index value is associated. In this way, the individual memory areas are associated in each case with one partition according to the memory configuration profile. The individual memory areas may thus be assigned to the processes via a corresponding partition or via the specific partition index value.

Via such partitioning, the individual processes or memory accesses of the processes may be advantageously carried out in isolation from other processes, so that freedom from interference and from collisions during memory accesses is made possible in a particularly advantageous manner. For example, time-critical processes may thus be shielded from memory collisions.

In addition, partitioning is thus not, for example, fixedly and unchangeably predefined a priori prior to initial start-up of the processing unit, but instead may be dynamically adapted during run time of the processing unit in a particularly advantageously flexible manner. In particular, a best possible classification of the individual memory areas into various partitions may thus be learned during ongoing operation of the processing unit.

Furthermore, it is also possible that the processes are not fixedly associated with the partitions, and instead this association may be adapted online. For this purpose, for determining the memory configuration profile at least one partition index value is advantageously associated in each case with the individual particular processes. In addition, a partition index value is associated in each case with the individual memory areas of the memory unit in order to assign these memory areas in each case to a particular process with which the same partition index value is associated. In particular, upon each occurrence of the predefined event it may thus be determined whether the association of the processes with the particular partitions is to be maintained or adapted. In particular, additional freedom in associating the memory areas with partitions results. In addition, it is also possible to react to new processes that have not previously been executed.

It is also possible to not associate all processes with a partition. At least one partition index value is preferably associated in each case only with predetermined processes, and thus in particular with only a portion of the processes to be executed in the processing unit. For example, time-critical processes may be associated with a partition index value or a partition to allow these processes to be isolated. In particular, in this case the memory unit is not completely subdivided into partitions. Only a portion of the memory areas are advantageously associated in each case with a partition, and shared access, for example, may be made to the remaining memory areas. For determining the memory configuration profile, a partition index value is preferably associated in each case with individual memory areas in order to assign these memory areas in each case to a particular process with which the same partition index value is associated. Alternatively or additionally, individual memory areas are directly assigned to particular processes with which no partition index value is associated.

Moreover, it is also possible to make the assignment of the memory areas as a function of a partitioning, but without specifying a specific partitioning. For this purpose the memory configuration profile is preferably determined as a function of partition information that describes an association in each case of processes, to be executed in the processing unit, with a partition index value. For example, this partition information may be determined during an offline phase or a calibration phase or test phase, in the course of which the processing unit is operated with software-based partitioning and examined. In particular, the memory access behavior or the access profile of the individual processes, in particular time-critical processes, may thus be learned. The partition information obtained with the aid of such test partitioning may be utilized during regular operation of the processing unit in order to allocate the memory areas in the best possible manner.

The method is suited for a wide range of application options, for example in automotive technology, aviation technology, industrial automation technology, etc.

The method is particularly preferably suited for application in the automotive sector. The processing unit may be designed in particular as a control unit or as a microcontroller or microprocessor in a (motor) vehicle. Processes that are executed by the processing unit may in particular be safety-critical functions that are carried out for safe operation and for controlling the vehicle, for example in the course of an engine control or in the course of driving assistance functions, etc. By use of the present method, in particular safety requirements in the automotive sector may be met, as specified, for example, in the ISO 26262 standard or in particular by the so-called Automotive Safety Integrity Level (ASIL), a safety requirement level for safety-relevant systems in motor vehicles specified by ISO 26262.

For example, the method is suited for use in conjunction with autonomous or automated driving. A plurality of various computing- and data-intensive processes are generally executed simultaneously in a multicore architecture. The method prevents occurrences of memory collisions and performance losses when such processes are executed.

In addition, the method is suited for a wide range of control systems in industrial automation technology, for example for machine or facility controllers. For example, in this context the processing unit may also be designed as a computerized numerical controller (CNC), numerical controller (NC), memory-programmable controller (MPC), motion logic controller (motion control (MC), etc., or may be encompassed by such a controller.

The method is particularly advantageously suited for real-time applications. In particular, individual or all processes to be executed by the processing unit are real-time critical processes that are to be executed according to a predefined real-time condition. By use of the method, in particular an execution of various processes free of interference and with temporal isolation may be made possible, so that real-time conditions may be met.

The present method may in particular be carried out by a management unit, which may be designed as a software unit or hardware unit on which appropriate software is executed. In particular, this management unit includes a configuration module that is configured to carry out the method steps of determining the memory configuration profile, analyzing the performance, and providing the analysis result. In addition, the management unit advantageously includes an assignment module that is set up to configure the memory unit according to the determined memory configuration profile. This configuration module and this assignment module in each case may also be designed as hardware and/or software modules.

A processing unit according to the present invention, for example a control unit of a motor vehicle, is configured, in particular by programming, to carry out a method according to the present invention.

In addition, the implementation of a method according to the present invention, in the form of a computer program or computer program product that includes program code for carrying out all method steps, is advantageous since it incurs particularly low costs, in particular when an executing control unit is also utilized for further tasks and therefore is present anyway. Lastly, a machine-readable memory medium is provided, including a computer program as described above that is stored thereon. Suitable memory media or data media for providing the computer program are in particular magnetic, optical, and electrical memories such as hard disks, flash memories, EEPROMs, DVDs, and others. In addition, downloading a program via computer networks (internet, intranet, etc.) is possible. Such downloading may take place in a wired or cabled manner or wirelessly (for example, via a WLAN, a 3G, 4G, 5G, or 6G connection, etc.).

Further advantages and embodiments of the present invention result from the description and the figures.

The present invention is schematically illustrated in the figures based on exemplary embodiments, and described below with reference to the figures.

### BRIEF DESCRIPTION OF THE DRAWINGS

FIG. 1 schematically shows one preferred example embodiment of a processing unit according to the present invention, which is configured to carry out one preferred specific example embodiment of a method according to the present invention.

FIG. 2 schematically shows one preferred specific example embodiment of a method according to the present invention as a block diagram.

### DETAILED DESCRIPTION OF EXAMPLE EMBODIMENTS

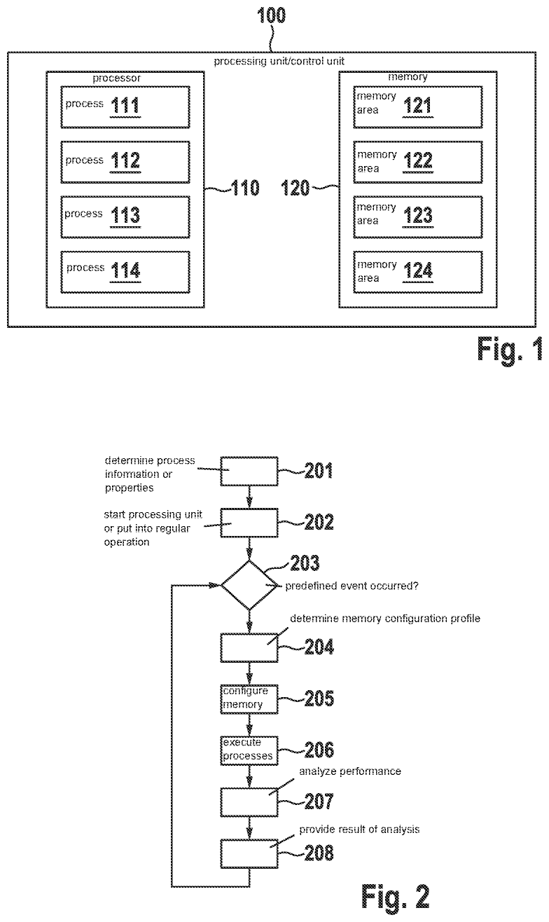

A processing unit is schematically illustrated in FIG. 1 and denoted by reference numeral 100. For example, processing unit 100 may be used in a (motor) vehicle and designed as a control unit. Control unit 100 executes safety-critical processes that are used for safe operation and for controlling the vehicle, for example in the course of engine control or in the course of autonomous or automated driving.

Control unit 100 includes a processor unit 110 that may be designed, for example, as a multicore processor with a plurality of processor cores on which a plurality of processes 111, 112, 113, 114 are executed in each case.

For example, processor unit 100 may execute time-critical processes or real-time processes that are to meet a real-time condition, as well as best effort processes that are to be executed as quickly as possible according to the so-called best effort principle.

Control unit 100 also includes a memory unit 120 that is designed as a cache memory, for example. Memory unit 120 includes a plurality of memory areas 121, 122, 123, 124, for example memory pages in the form of virtual or logical memory areas, which may be addressed with the aid of virtual or logical memory addresses. These virtual memory addresses may be translated into actual, physical memory addresses in order to map virtual memory areas 121, 122, 123, 124 onto actual, physical memory areas (so-called memory frames).

The illustration of executed processes 111, 112, 113, 114 and of memory areas 121, 122, 123, 124 is purely schematic and by way of example. It is understood that an even greater number of processes may be executed on the individual processor cores, and that memory unit 120 may also include a greater number of memory areas. Furthermore, it is understood that processing unit 100 may include even further components, for example further memory units, terminals for connection to peripheral devices, etc.

Individual processes 111, 112, 113, 114 executed in processor unit 100 may temporally and jointly access memory unit 120 as well as individual memory areas 121, 122, 123, 124 of memory unit 120. To prevent the occurrence of memory collisions and to prevent the processes from influencing one another's execution, processing unit 100 is configured, in particular by programming, to carry out one preferred specific embodiment of a method according to the present invention, schematically illustrated as a block diagram in FIG. 2 and explained in greater detail below.

Process information concerning individual processes 111, 112, 113, 114 to be executed in processing unit 100 or properties of these processes is determined in a step 201. This process information may describe a relevance, priority, or criticality of the individual processes. For example, the process information describes whether the individual processes are in each case a time-critical process. In addition, the process information may describe requirements of the individual processes, for example assigned priority values and a required quality of service or QoS requirements.

In addition, an access profile that describes accesses of individual processes 111, 112, 113, 114 to memory unit 120 is determined in step 201. For example, this access profile describes the number or size of data which the individual processes access in the course of their execution or which the processes cache during their execution. For example, the access profile also describes the particular number of memory areas accessed by the individual processes in each case, and whether or how often the individual processes in each case re-access the same memory area.

For example, the determining of the process information and of the access profile may be carried out offline prior to an initial start-up of processing unit 100 in the course of step 201, or for example also during a manufacturing or programming process of the processing unit or the software that is to be executed in processing unit 100. For example, the process information and the access profile may be predefined by a corresponding software manufacturer and stored in processing unit 100.

Furthermore, the process information and the access profile may also be determined during an offline phase or a calibration phase or test phase after initial start-up of processing unit 100. For example, the process information and the access profile may also be determined with the aid of statistical methods, for example by use of a surrogate model. In addition, the process information and the access profile may also be determined, for example, by analyzing a code underlying the processes, for example with the aid of static analysis tools.

Processing unit 100 is put into operation or the regular operation of processing unit 100 is started in a step 202.

It is checked in a step 203 whether a predefined event occurs. For example, this predefined event may be the expiration of a predefined time interval, the start of a new process, or the receipt of a request to execute a new process, or also the end of an executed process. In addition, the predefined event may include a predefined criterion, for example reaching a threshold value of an error counter, for example reaching a threshold value of a number of failed memory accesses, memory lapses, or cache misses.

Upon occurrence of the predefined event, a memory configuration profile according to which individual processes 111, 112, 113, 114 are in each case allowed to access individual memory areas 121, 122, 123, 124 of memory unit 120 is determined in step 204.

The determining of this memory configuration profile takes place as a function of the process information determined in step 201 and the access profile determined in step 201. For example, particular memory areas 121, 122, 123, 124 may in general be reserved for access by particular processes 111, 112, 113, 114, without specific assignments.

In addition, individual memory areas 121, 122, 123, 124 may also be specifically assigned to particular processes 111, 112, 113, 114. For this purpose, in general it may be initially determined how many memory areas are assigned to a particular process. It is subsequently determined in particular which specific memory areas are assigned to this process. A memory area in question is assigned to a particular process in such a way that only one of these processes is allowed exclusive access to this memory area.

The assignment of the individual memory areas takes place in such a way that no conflicts or collisions can occur when the memory areas are being accessed, and that requirements of the individual processes, for example real-time conditions or best effort-conditions, may be met.

The individual memory areas may, for example, be directly assigned to the particular processes. In addition, the assignment may also take place with the aid of software-based partitioning, for example. For this purpose, in each case at least one partition index value may be associated with each process 111, 112, 113, 114 to be executed in processing unit 100, for example a color or a color value (coloring, cache coloring, or page coloring). For example, this association may be made a priori, or the association may take place online in the course of determining the memory configuration profile.

Within the scope of the memory configuration profile, a memory area is assigned to a process, for example by associating the same partition index value to this memory area as for the particular process.

Furthermore, for example at least one partition index value may be associated in each case with only a portion of processes 111, 112, 113, 114 to be executed in processing unit 100. Thus, within the scope of the memory configuration profile, an appropriate partition index value may be associated with a portion of memory areas 121, 122, 123, 124, and another portion may be directly assigned to processes.

Moreover, the memory configuration profile may be determined as a function of partition information that is determined, for example, during an offline phase or a calibration phase or test phase, in the course of which processing unit 100 is operated with appropriate software-based partitioning and examined in order to learn the memory access behavior of processes 111, 112, 113, 114. The assignment of memory areas 121, 122, 123, 124 may thus be determined as a function of partitioning that takes place offline, without carrying out specific partitioning online.

In a step 205, memory unit 120 is configured so that in general, individual processes 111, 112, 113, 114 are each allowed to access particular individual memory areas 121, 122, 123, 124 according to the determined memory configuration profile, or in the special case of cache coloring, so that individual memory areas 121, 122, 123, 124 are assigned to particular processes 111, 112, 113, 114 according to the determined memory configuration profile. Thus, the memory configuration profile is implemented in memory unit 120 in step 205. For example, for this purpose entries in a memory management table may be changed, or for example a bit in an operating system of processing unit 100 may be set or changed.

Individual processes 111, 112, 113, 114 are now executed in processing unit 100, and access assigned memory areas 121, 122, 123, 124 according to the memory configuration profile, in a step 206.

A performance of processing unit 100 is analyzed in a step 207 while processes 111, 112, 113, 114 are accessing assigned memory areas 121, 122, 123, 124 according to the memory configuration profile. In the course of this analysis, for example present performance properties are determined which describe a performance of executed processes 111, 112, 113, 114 and of overall processing unit 100, for example execution time, latency, or waiting times as well as successful or unsuccessful memory accesses (cache hits, cache misses). These present performance properties are compared to predefined performance conditions which represent, for example, setpoint values, limiting values, or threshold values for the performance properties.

In step 208 a result of this analysis 207 is provided which states, for example, whether the present performance properties at least essentially match the predefined performance conditions, or how greatly the present performance properties deviate from the predefined performance conditions.

Steps 204 through 208 may be iteratively repeated during operation of processing unit 100, in each case triggered by occurrence of the predefined event. The analysis result determined in step 208 is provided for taking it into account for determining the memory configuration profile upon a next occurrence of the predefined event. If the predefined event according to step 203 reoccurs, the memory configuration profile is redetermined in step 204, in particular as a function of the determined analysis result.

If a process that has already been executed in processing unit 100 is now re-executed, based on the analysis result the effectiveness of the assignment of the particular memory areas to this process may be assessed. For example, if the performance property of this process, for example its execution time, essentially matches the associated performance condition or the associated setpoint value, the most recent assignment of memory areas to this process may be maintained. However, if the performance property of this process deviates from the performance condition, a new assignment of memory areas may be determined. In contrast, if a new process which has not yet been executed in processing unit 100 is to be executed, a completely new memory configuration profile may also be determined.

By such iterative determination and analysis of the memory configuration profile, the assignment of memory areas may be dynamically adapted online and improved, so that over time a best possible allocation of the memory areas may be learned.

1-14. (canceled)

15. A computer-implemented method for managing memory areas of a memory unit in a processing unit, the method comprising the following steps:
determining, upon occurrence of a predefined event, a memory configuration profile according to which individual processes are each allowed to access respective individual memory areas of the memory unit;
configuring the memory unit according to the determined memory configuration profile in such a way that the individual processes are each allowed to access the respective individual memory areas of the memory unit;
analyzing a performance of the processing unit while the individual processes are being executed in the processing unit and are accessing the respective individual memory areas according to the determined memory configuration profile; and
providing a result of the analysis which describes the performance of the processing unit as a function of the determined memory configuration profile.

16. The method as recited in claim 15, wherein the determining of the memory configuration profile is carried out as a function of:
process information that describes a relevance of the individual processes to be executed on the processing unit, and/or
an access profile that describes accesses of the memory unit by the individual processes to be executed on the processing unit.

17. The method as recited in claim 15, wherein the occurrence of the predefined event includes:
receiving a request for executing one or multiple processes, and/or
ending the execution of one or multiple of the individual processes, and/or expiration of a predefined time interval and/or
occurrence of a predefined criterion relating to the performance.

18. The method as recited in claim 15, wherein the analyzing of the performance of the processing unit includes:
determining performance properties that describe a performance of the execution of the individual processes and/or a performance of operation of the overall processing unit, and
comparing the determined performance properties to predefined performance conditions that describe a predefined performance for the execution of the individual processes and/or a predefined performance for the operation of the overall processing unit.

19. The method as recited in claim 18, further comprising:
providing the result of the analysis for taking it into account for determining the memory configuration profile upon a next occurrence of the predefined event, and/or
redetermining, upon a next occurrence of the predefined event, the memory configuration profile as a function of a most recently determined memory configuration profile and as a function of the provided result of the analysis.

20. The method as recited in claim 19, wherein the redetermining of the memory configuration profile includes:
using the most recently determined memory configuration profile when as the result of the analysis, it is determined that the performance properties match the predefined performance conditions, and/or
adapting the most recently determined memory configuration profile when as the result of the analysis it is determined that the performance properties deviate from the predefined performance conditions.

21. The method as recited in claim 15, wherein the performance of the processing unit relates to:
a response time of the individual processes, and/or
errors when accessing data of the individual processes.

22. The method as recited in claim 15, wherein at least one partition index value is associated with each of the individual processes to be executed in the processing unit, and the determining of the memory configuration profile includes:
associating each partition index value with the individual memory areas of the memory unit to assign the individual memory areas in a process of the individual processes which the same partition index value is associated.

23. The method as recited in claim 15, wherein the determining of the memory configuration profile includes:
associating at least one partition index value with each of the individual processes,
associating a partition index value with each of the individual memory areas of the memory unit in order to assign each of the individual memory areas to a particular process of the individual processes with which the same partition index value is associated.

24. The method as recited in claim 15, wherein a partition index value is associated with certain of the individual processes to be executed in the processing unit, and the determining of the memory configuration profile includes:
associating at least one partition index value to each of the individual memory areas of the memory unit to assign each of the individual memory areas to a particular process of the individual processes with which the same partition index value is associated, and/or
directly assigning individual memory areas to particular processes of the individual processes with which no partition index value is associated.

25. The method as recited in claim 15, wherein the determining of the memory configuration profile is carried out as a function of:
partition information that describes an association of each of the individual processes to be executed in the processing unit with a partition index value.

26. A processing unit configured to manage memory areas of a memory unit in the processing unit, the processing unit configured to:
determine, upon occurrence of a predefined event, a memory configuration profile according to which individual processes are each allowed to access respective individual memory areas of the memory unit;
configure the memory unit according to the determined memory configuration profile in such a way that the individual processes are each allowed to access the respective individual memory areas of the memory unit;
analyze a performance of the processing unit while the individual processes are being executed in the processing unit and are accessing the respective individual memory areas according to the determined memory configuration profile; and
provide a result of the analysis which describes the performance of the processing unit as a function of the determined memory configuration profile.

27. A non-transitory machine-readable memory medium on which is stored a computer program for managing memory areas of a memory unit in a processing unit, the computer program, when executed by a computer, causing the computer to perform the following steps:
determining, upon occurrence of a predefined event, a memory configuration profile according to which individual processes are each allowed to access respective individual memory areas of the memory unit;
configuring the memory unit according to the determined memory configuration profile in such a way that the individual processes are each allowed to access the respective individual memory areas of the memory unit;
analyzing a performance of the processing unit while the individual processes are being executed in the processing unit and are accessing the respective individual memory areas according to the determined memory configuration profile; and
providing a result of the analysis which describes the performance of the processing unit as a function of the determined memory configuration profile.
